(19) United States
(12) Patent Application Publication
(10) Pub. No.: US 2022/0135007 A1
(43) Pub. Date: May 5, 2022

(54) DRIVE DEVICE FOR A VEHICLE, VEHICLE AND METHOD FOR BRAKING A DRIVE DEVICE

(71) Applicant: JHEECO E-DRIVE AG, Eschen (LI)

(72) Inventors: German SCHIDLOWSKI, Wasserburg (DE); Philipp MATT, Frastanz (AT); Roland BUOL, Wangs (CH); Barna SZIMANDL, Gams (CH)

(21) Appl. No.: 17/435,664

(22) PCT Filed: Feb. 26, 2020
(86) PCT No.: PCT/EP2020/054954

§ 371 Date: Sep. 1, 2021

(30) Foreign Application Priority Data
Mar. 1, 2019 (DE) 10 2019 202 849.7

(51) Int. Cl. B60T 1/087; B60K 1/00; F16D 63/00; H02K 7/00; H02K 7/10

(52) U.S. Cl. CPC B60T 1/087; B60K 1/00; B60K 2001/001; H02K 7/006; H02K 7/10; F16D 63/00

(57) ABSTRACT

The invention relates to a drive device for a vehicle, comprising at least one electric machine, in particular an electric motor, having a rotor and a stator, a drive axle and a main service brake, the drive device being equipped with an additional service brake in the form of a fluid gap brake, comprising a fluid gap which is situated between the rotor and the stator and can be flooded with a fluid to achieve a braking effect. The invention also relates to a vehicle having a drive device having a fluid gap brake and to a method for braking a drive device by means of the fluid gap brake, characterized by the following method steps: —flooding the fluid gap with fluid from a reservoir by means of the flooding device; —emptying the fluid gap of fluid into a reservoir by means of the drainage device.

The present invention relates to a drive device for a vehicle, a vehicle, and a method for braking a drive device.

A drive device for a vehicle essentially comprises an electric machine, in particular electric motor, a drive axle, and a main service brake. The driving force of the electric machine is transmitted to the drive axle, optionally via a transmission, the drive axle in turn driving a wheel. The main service brake is a brake which can ensure a delay (deceleration) of the driven vehicle in the driving operation. Usually, so-called friction brakes are employed for this.

It is legal standard that service brakes for vehicles have to be friction brakes. For extreme situations, the brake systems are always designed for decelerations above the legal standard. Therefore, for this field, other (non-friction) brake systems are also admissible to supplement the main service brake.

For this, DE102009027478A1 suggests, for example, to combine a conventional outboard brake system with a further brake system. Explicitly, the use of a magnetic brake and of friction brakes attached remote from the wheel (inboard brake) is suggested. The inboard brake can also be designed electromechanically. As outboard brake systems, usually those brakes are meant which are positioned near the wheel and remote from the drive. In contrast, inboard brake systems are brakes remote from the wheel and near the drive.

Such a combination of brakes, however, causes a considerable weight. Moreover, with a magnetic brake, numerous parameters, such as the conductivity of the brake disc, the direction of the magnetic field, the shape of the disc, have to be matched to achieve a sufficient braking effect.

This is what the invention addresses, and it is the object of the invention to provide an improved drive unit, in particular a drive unit with a main service brake and an additional brake which is of a simple design and causes only few additional efforts.

According to the invention, this object is achieved by a drive device having the characterizing features of claim 1. By the drive device being equipped with an additional service brake designed as a fluid gap brake, comprising a fluid gap arranged between the rotor and the stator which can be flooded with a fluid for achieving a braking effect, an additional brake of a simple design which can be realized with only few additional efforts to support the main service brake is provided. The fluid gap brake can be employed, depending on the activation, as a brake for extreme situations (emergency braking, alpine pass descents, etc.), or as a supporting service brake. In both cases, this assists to reduce the brake lining wear and brake particle emissions of the main service brake. In particular, conventional outboard brakes can be eliminated.

Flooding the fluid gap with a fluid is here to be understood essentially as the flooding with a liquid, such as oil, which displaces the preferably gaseous fluid, such as air, optionally previously located in the fluid gap. This fluid can also be referred to as brake fluid. It is also possible that the fluid gap was free from fluid or evacuated (in the technical sense) before flooding.

Further advantageous embodiments of the suggested invention in particular result from the features of the subclaims. The objects or features of the different claims can be basically arbitrarily combined with each other.

In an advantageous embodiment of the invention, a transmission can be arranged downstream of the electric machine. Apart from the usual functions of a transmission, in particular distribution, transmission, speed reduction etc., of the speed or torque, respectively, introduced by the electric machine, the gear oil usually present in the transmission can be used as a fluid for the fluid gap brake. The transmission can quasi serve as a reservoir for the fluid and be withdrawn from it and in particular also be returned to it. Moreover, the gear oil circulation pump, which is anyway present in most cases, can be used for the fluid gap brake, in particular as a flooding device.

In a further advantageous embodiment of the invention, the drive device can comprise a first drive axle and a second drive axle, the transmission being arranged between the drive axles and the electric machine being coupled to the transmission, wherein a first main service brake is provided which acts on the first drive axle, wherein a second main service brake is provided which acts on the second drive axle.

The first and second drive axles are in particular half axles which are connected to each other via a differential, wherein an electric machine is embodied to drive both half axles. However, it is also conceivable and possible that each half axle has a separate drive device which each comprises an electric machine and preferably a transmission each.

In a further advantageous embodiment of the invention, the main service brake can be designed as an inboard brake. In particular to reduce spring-loaded masses, it is advantageous to position brakes remote from the wheel and preferably near the drive.

In a further advantageous embodiment of the invention, the electric machine, the transmission, the main service brakes and the additional service brake embodied as a fluid gap brake can be attached at or accommodated in a common housing. By this, a compact drive device can be provided which can be installed in a vehicle in particular as a compact unit.

The basic principle of the fluid gap brake is to introduce a fluid into a region between the rotor and the stator to slow down a rotating rotor of the electric machine. A flooding device is used for this purpose. In case of flooding, energy is converted into heat by viscous friction in the fluid gap between the stator and the rotor. This braking effect is cancelled by pumping out this introduced fluid from the region between the rotor and the stator by a drainage device. The region to be filled with the fluid or to be emptied of the fluid will be referred to as fluid gap below. Usually, the fluid gap brake has a reservoir in which the fluid is stored to be discharged to the fluid gap and/or can be received to be returned from the fluid gap.

Insofar, the fluid gap brake is preferably equipped with a flooding device for flooding the fluid gap with fluid, and in particular a drainage device for draining or emptying the fluid gap, and/or a reservoir for storing the fluid.

For designing the flooding device, the drainage device, and/or the reservoir, various possibilities are conceivable.

For example, the flooding device can comprise a pump, a pressure chamber, an electric machine under vacuum, in particular a fluid gap under vacuum, or a pre-chamber with a capsule with a propellant.

Furthermore, the drainage device can preferably comprise a pump, an exhauster chamber under vacuum, a self-evacuating fluid gap, and/or an impeller driven by the rotor.

Furthermore, the reservoir can preferably comprise the transmission, the pressure chamber and/or the pre-chamber. By this, too, already existing components are utilized for the fluid gap brake, which in particular saves weight.

In a preferred embodiment of the drive device, the flooding device can comprise a first pump, and the drainage device can comprise a second pump, the reservoir comprising the transmission. By using pumps, an exact control of the fluid flow, and thus an exact dosing of the additional braking effect to be achieved, can be effected.

In a preferred development of the drive device, and in particular the above-mentioned drive device, the drainage device can comprise a self-evacuating fluid gap and/or an impeller driven by the rotor. In particular the self-evacuating fluid gap and/or the impeller driven by the rotor can preferably be employed as a support for the drainage device designed as a pump. In particular, draining can be accelerated thereby, whereby in particular when employed in a vehicle, a better applicability results since the additional braking effect can be employed for smaller windows of time. At the same time, the impeller can also serve as an additional flow resistance with a flooded fluid gap or a flooded motor interior to thus increase the braking effect.

In an advantageous embodiment of the invention, the flooding device can comprise a pump and a pressure chamber, the drainage device comprising a pump, the reservoir comprising the transmission and the pressure chamber. By the pressure chamber, high flooding powers can be provided within a short time, wherein the pressure can be provided over extended periods of time at a comparatively low power.

In a preferred embodiment of the drive device, the flooding device can comprise an electric machine under vacuum, in particular a fluid gap under vacuum, wherein the drainage device comprises an exhauster chamber under vacuum, wherein the reservoir comprises the transmission. By the vacuum, reaction times when the fluid gap brake is switched on or off can be reduced since a vacuum provides high power at a short activation time (valve switch). It is furthermore possible to build up the vacuum over a long period, so that devices for creating a vacuum can be selected with a very low power.

In a preferred embodiment of the drive device, the flooding device can comprise a propellant capsule, in particular gas cartridge, installed in a fluid-filled pre-chamber, wherein the drainage device comprises a collection chamber arranged below the electric machine, in particular the fluid gap, in the direction of gravity, wherein the reservoir comprises the pre-chamber. Such a drive device or fluid gap brake can be constructed at very low costs, in particular since expensive components, such as pumps etc., are not required. On the other hand, this embodiment is preferably provided for emergency brakes since they are not reusable without any problems.

In a further advantageous embodiment of the invention, gear oil, in particular the gear oil present in the transmission, can be used as the fluid. Such a fluid is anyway contained in the transmission and can preferably be used as the fluid for the fluid gap brake.

In a further advantageous embodiment, the fluid gap brake can be embodied with an additional flow resistance, in particular a separate paddle wheel attached on the rotor shaft or blades attached to the front side of the rotor. The flow resistances submerge into the brake fluid when the fluid gap is flooded or the motor interior is flooded, and thus increase the braking effect.

A further object of the present invention is to suggest an improved vehicle, preferably a vehicle with an improved drive device, in particular an improved fluid gap brake.

According to the invention, this object is achieved by a vehicle having the characterizing features of claim 16. By the use of a drive device/fluid gap brake according to the invention, the above outlined advantages can be made usable for a vehicle.

A further object of the present invention is to suggest a method for braking a drive device according to one of the preceding claims by means of the fluid gap brake.

According to the invention, this object is achieved by the following method steps:

flooding the fluid gap with fluid from a reservoir by means of the flooding device,

emptying the fluid gap of fluid into a reservoir by means of the drainage device.

As flooding devices or drainage devices, respectively, in particular, the devices outlined below can be used. Flooding the fluid gap means a flooding sufficient for the braking effect to be achieved. Draining moreover means an emptying to be carried out to obtain a desired cancellation of the braking effect. One cannot exclude that residuals of the fluid remain in the fluid gap but do not achieve any braking effect any longer.

Moreover, the fluid does not necessarily have to be returned to the same reservoir from which it has been withdrawn. However, this is desirable under the aspect of a closed circuit.

Further features and advantages of the present invention will become clear with respect to the following description of preferred embodiments with reference to the enclosed drawings. In the drawings

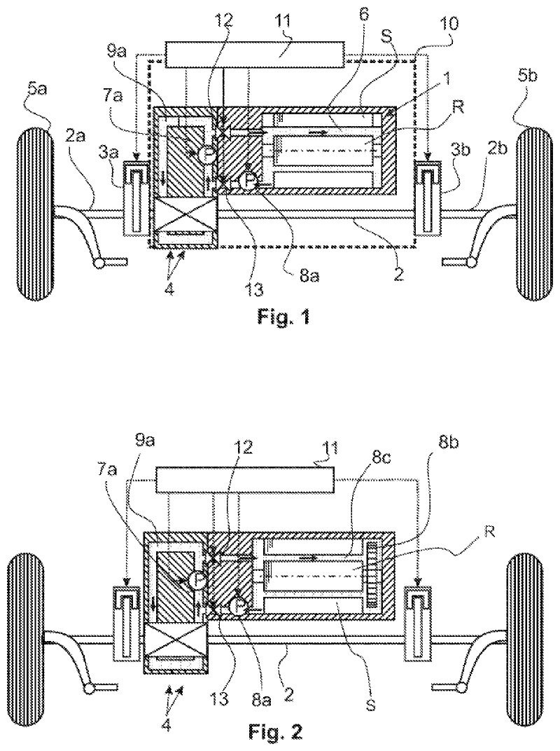

FIG. 1 shows a drive device according to the invention in a schematic representation;

FIG. 2 shows a drive device according to the invention in a schematic representation;

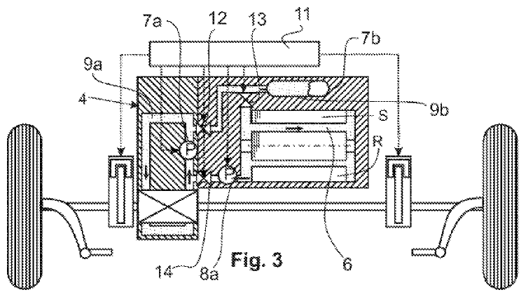

FIG. 3 shows a drive device according to the invention in a schematic representation;

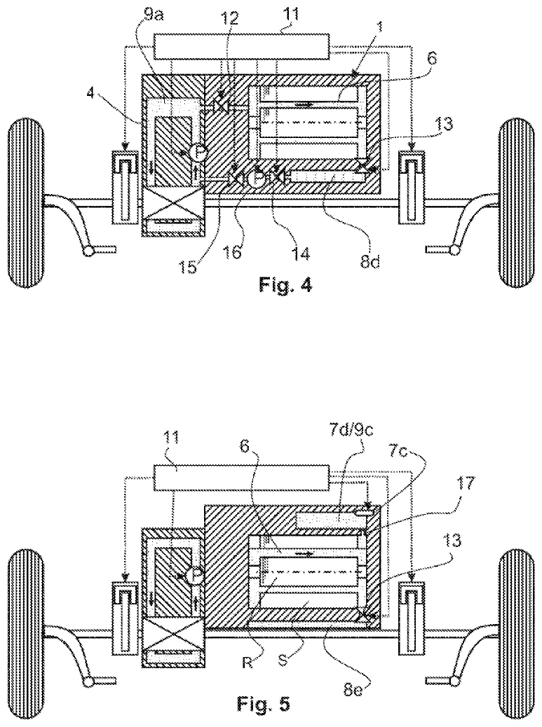

FIG. 4 shows a drive device according to the invention in a schematic representation;

FIG. 5 shows a drive device according to the invention in a schematic representation;

FIG. 6 shows a measurement curve from a test in which the additional brake was activated;

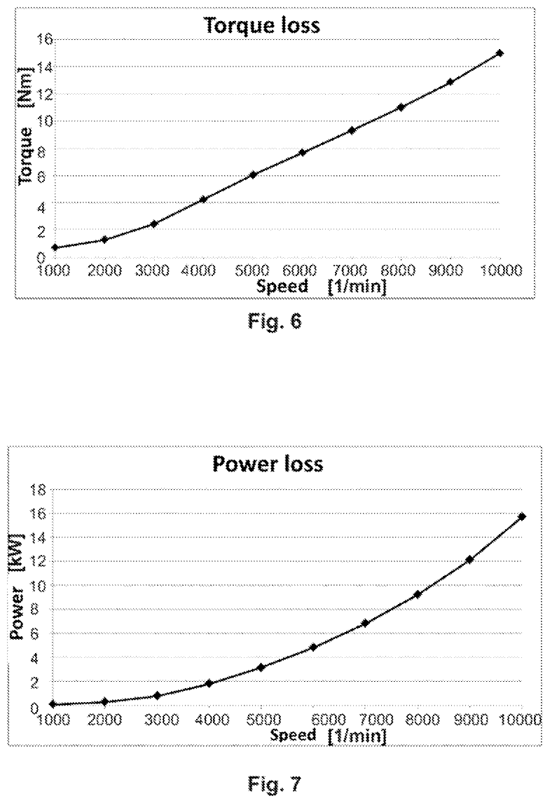

FIG. 7 shows a measurement curve from a test in which the additional brake was activated.

The following reference numerals are used in the drawings:
R rotor
S stator
1 electric machine
2 (a/b) drive axle
3 (a/b) main service brake
4 transmission
5 (a/b) drive wheel
6 fluid gap
7 (a-d) flooding device
8 (a-e) drainage device
9 reservoir
7a pump
7b pressure chamber
7c propellant capsule
7d pre-chamber
8a pump
8b impeller
8c self-evacuating fluid gap
   8d exhauster chamber
   8e collection chamber
9a reservoir in the transmission
9b reservoir in the pressure chamber
9c reservoir in the pre-chamber
10 housing
11 brake control unit
12 valve
13 valve
14 valve
15 valve
16 pump
17 membrane

A drive device for a vehicle, in particular a motor vehicle, comprises at least one electric machine 1, a drive axle 2a, a main service brake 3a, and according to the invention, an additional service brake embodied as a fluid gap brake. An additional brake or additional service brake, respectively, means a brake supporting the main service brake and not, for example, a parking brake. The additional brake is rather to serve to support the main service brake and to finally also permit an additional retardation of the drive wheels in a moved vehicle or drive device, respectively.

Preferably, the drive device includes a transmission 4 and a first drive axle 2a with a first drive wheel 5a, and a second drive axle 2b with a second drive wheel 5b. The first drive axle 2a is preferably attached between the transmission 4 and the first drive wheel 5a, and the second drive axle 2b is preferably attached between the transmission 4 and the second drive wheel 5b.

Preferably, a first main service brake 3a and a second main service brake 3b are provided. The first main service brake 3a acts on the first drive axle 2a, and the second main service brake 3b acts on the second drive axle 2b.

The electric machine 1, the transmission 4, and the main service brakes 3a, 3b preferably form a compact unit and are furthermore preferably received in a common housing 10.

The main service brakes 3a, 3b are to be referred to as inboard brake due to their arrangement remote from the drive wheels and near or within the housing. With respect to the active principle, the main service brakes 3a, 3b, are preferably so-called friction brakes, specifically disc brakes or drum brakes. The activation can be effected electromechanically.

As already illustrated, according to the invention, the drive device is equipped with an additional service brake in the form of at least one fluid gap brake.

The basic principle of the fluid gap brake is to introduce a fluid in a region between the rotor R and the stator S to slow down a rotating rotor R of the electric machine 1. The fluid is indicated as an undulated shading in the illustrations. A flooding device is used for this purpose. In case of flooding, energy is converted into heat by viscous friction in the fluid gap between the stator S and the rotor R. This braking effect is cancelled by pumping out this introduced fluid from the region between the rotor R and the stator S by a drainage device. The region to be filled with the fluid or to be emptied of the fluid will be referred to as fluid gap below. Usually, the fluid gap brake has a reservoir in which the fluid is stored to be discharged to the fluid gap and/or can be received to be returned from the fluid gap. The fluid for flooding the fluid gap (brake fluid) differs from the optionally other fluid which is present in the fluid gap when the fluid gap brake is not activated and no braking effect is desired. The brake fluid can be a gas, in particular if the fluid gap is free from fluid or evacuated (in a technical sense) when the fluid gap brake is not activated. The brake fluid can also be a liquid which displaces fluid optionally present in the fluid gap, such as air, when the fluid gap is flooded with the brake fluid.

For the drive device, in particular its fluid gap brake, different embodiments are conceivable, in particular in view of the design of the flooding device, the drainage device, and/or the reservoir. Moreover, functions in devices can be combined or one device can perform a plurality of functions. Below, some not exhaustively listed variants will be presented.

The flooding device can comprise, for example, a pump 7a, a pressure chamber 7b, an electric machine 1 under vacuum, in particular a fluid gap 6 under vacuum, and/or a propellant capsule 7c in a pre-chamber 7d.

The drainage device can comprise a pump 8a, an impeller 8b connected to the rotor R, a self-evacuating fluid gap 8c, an exhauster chamber 8d under vacuum, and/or a collection chamber 8e arranged below the electric machine 1, in particular the fluid gap 6, in the direction of gravity.

The reservoir 9b or 9c, respectively, can be formed by the pressure chamber 7b or the pre-chamber 7d itself, and also by the transmission 4. Basically, however, any vessel can be used as the reservoir for the fluid by which the fluid gap 6 is flooded. In particular if the transmission 4 is used as the reservoir 9a, gear oil can be used as the fluid. Basically, however, other suited fluids can also be used.

The aforementioned variants can basically be arbitrarily combined with each other. Furthermore, the person skilled in the art will appreciate that the above outlined devices can be optionally supplemented by further components, such as, for example, valves, control technology, in particular a brake control unit 11, pipelines etc.

Below, some, however not exhaustively all, combinations of the above-mentioned flooding and drainage devices or reservoirs will be described more in detail.

In FIG. 1, a drive device is represented in which the flooding device comprises a first pump 7a, and the drainage device comprises a second pump 8a. The reservoir 9a is formed by the transmission 4. As a fluid, the gear oil anyway present in the transmission 4 is correspondingly used. As a pump 7a for flooding the fluid gap 6, the gear oil circulation pump anyway provided for circulating the gear oil can be used for flooding the fluid gap 6, but optionally, a separate pump can also be used.

The function of this drive device, in particular the fluid gap brake, can be outlined as follows. A brake control unit 11 opens a valve 12 between the transmission 4 and the electric machine 1, in particular fluid gap 6, in case of a braking operation. The fluid gap 6 is flooded actively by the pump 7a. For pumping off, the pump 8a is activated and pumps the fluid from the fluid gap 6 back into the transmission 4 or the gear oil circuit. Between the pump 8a and the transmission 4, a valve 13 can be provided which is opened before the pumping process.

In the following embodiments, too, the flooding and drainage devices 7 and 8, respectively, are controlled by the brake control unit 11.

FIG. 2 shows a variation of the embodiment of FIG. 1, wherein the flooding device additionally comprises an impeller 8b. The impeller is formed, for example, by a paddle wheel attached at the front side of the rotor R.

The impeller 8b is configured to remove the fluid from the fluid gap 6 when the valve 13 is opened. In addition or as an alternative, the drainage device can also comprise a self-evacuating fluid gap 8c. To this end, the rotor R can be designed with corresponding blades in the fluid gap 6, for example. Both the impeller 8b and the self-evacuating fluid 8c can alternatively also be employed as drainage device. At the same time, the impeller 8b acts as a flow resistance when the valve 13 is closed and increases the braking effect of the fluid gap brake.

FIG. 3 shows a variant of the embodiment in which the flooding device comprises a pump 7a and a pressure chamber 7b, optionally with a pressure bubble. As a drainage device, here, too, a pump 8a is employed. The reservoir 9 is here formed both by the transmission 4 and the pressure chamber 7b.

The function of this drive device, in particular fluid gap brake, can be outlined as follows. Between the transmission 4 and the pressure chamber 7b, a valve 12 is provided. The valve 12 is opened and the pressure chamber 7b is pre-filled via the pump 12, wherein a nearly incompressible fluid, such as oil, can also be pre-tensioned by the pressure bubble. The pump 12 can be the gear oil circulation pump which is anyway present.

In case of a braking operation, a valve 13 between the pressure chamber 7b and the electric machine 1, in particular the fluid gap 6, is opened, so that the fluid under pressure flows from the pressure chamber 7b into the fluid gap 6. The valve 12 is blocked to prevent a return flow of the brake fluid into the reservoir 9a. For draining, analogously to the embodiment according to FIG. 1, the pump 8a is activated and pumps the fluid again into the transmission 4 or the transmission circuit. Between the pump 8a and the transmission 4, a valve 14 can be provided.

FIG. 4 shows a variant of the embodiment in which the flooding device comprises an electric machine 1 under vacuum, in particular a fluid gap 6 under vacuum. The drainage device comprises an exhauster chamber 8d under vacuum. The reservoir 9 is formed by the transmission 4.

The function of this drive device, in particular the fluid gap brake, can be outlined as follows.

Between the electric machine 1, in particular the fluid gap, and the transmission 4, a valve 12 is provided. The exhauster chamber 8d and a pump 16 are connected to the electric machine 1, in particular the fluid gap. Furthermore, between the exhauster chamber 8d and the electric machine 1, in particular the fluid gap, a valve 13 is provided, and between the exhauster chamber 8d and the pump 16, a valve 14 is provided. Preferably, a valve 15 is provided between the pump 16 and the transmission 4.

Initially, the valve 12 is closed and the valves 13 and 14 are open. By the pump 16, both the electric machine 1, in particular the fluid gap 6, and the exhauster chamber 8d are evacuated or a vacuum is created. Thereby, undesired frictional losses of the electric machine 1 are reduced. After a technically required vacuum is reached, the valves 13 and 14 are closed and the pump 16 switched off. The valve 12 remains closed.

In case of a braking operation, the valve 12 between the transmission 4 and the electric machine 1, in particular the fluid gap 6, is opened, so that fluid is exhausted from the transmission 4, in particular from the gear oil circuit, into the electric machine 1, in particular the fluid gap 6. For draining, the valve 12 is closed and the valve 13 opened, so that the fluid flows from the electric machine 1, in particular the fluid gap 6, into the exhauster chamber 8d. By opening the valve 14 and the valve 15 and by activating the pump 16, the exhauster chamber 8d is drained into the transmission 4.

FIG. 5 shows a variant of the embodiment in which the flooding device comprises a propellant capsule 7c, in particular gas cartridge, which is installed in a fluid-filled pre-chamber 7d. The drainage device comprises a collection chamber 8e arranged below the electric machine 1, in particular the fluid gap 6, in the direction of gravity. It is furthermore a variant of the embodiment which is to do without the transmission 4 as the reservoir. Insofar, the pre-chamber represents the reservoir 9c for providing the fluid.

The function of this drive device, in particular fluid gap brake, can be outlined as follows. In case of a braking operation, the gas cartridge 7c is ignited and the fluid is pressed out of the pre-chamber 7d into the electric machine 1, in particular the fluid gap 6. A membrane 17 can be provided between the pre-chamber 7d and the electric machine 1, in particular the fluid gap 6, which is destroyed by the pressure of the gas cartridge and releases the passage. After a braking effect has been exerted, a valve 13 between the electric machine 1, in particular the fluid gap 6, will open, and the fluid will flow off into the collection chamber 8e, preferably due to gravity. This variant is preferably usable only once and designed for emergency braking. By the drainage device, the drive device remains operable; it can in particular be returned to its original state by corresponding repair or overhaul.

FIGS. 6/7 show real measurement curves from a test in which the engine gap was fluid-flooded. The braking power depends on velocity. The idea according to the invention is therefore in particular suited for emergency braking from high velocities.

Features and details described in connection with a method naturally also apply in connection with the device according to the invention, and vice versa, so that with respect to the disclosure, mutual reference is made, and can be made, to the individual aspects of the invention. Moreover, an optionally described method according to the invention can be carried out by the device according to the invention.

A main application of the drive device according to the invention will be the application in a vehicle. Moreover, the electric machine is preferably an electric motor. However, an electric generator or an electric motor acting as a generator is also conceivable.

Braking can be performed as “blended braking”, so that the braking power is provided by the main service brakes, the fluid gap brake, and optionally an additional recuperation braking, in particular of the electric machine.

1. Drive device for a vehicle, comprising at least one electric machine, in particular an electric motor, with a rotor and a stator, a drive axle and a main service brake, wherein the drive device is equipped with an additional service brake designed as a fluid gap brake, comprising a fluid gap arranged between the rotor and the stator which is configured to be flooded with a fluid for achieving a braking effect.

2. Drive device according to claim 1, wherein a transmission is arranged downstream of the electric machine.

3. Drive device according to claim 2, wherein the drive device includes a first drive axle, a second drive axle, wherein the transmission is arranged between the drive axles, and the electric machine is coupled to the transmission, wherein a first main service brake which is configured to act on the first drive axle is provided, wherein a second main service brake which is configured to act on the second drive axle is provided.

4. Drive device according to claim 1, wherein the main service brake is designed as an inboard brake.

5. Drive device according to claim 3, wherein the electric machine, the transmission, the main service brakes, and the additional service brake designed as a fluid gap brake are attached at or accommodated in a common housing.

6. Drive device according to claim 5, wherein the fluid gap brake is equipped with a flooding device for flooding the fluid gap with a fluid, and in particular a drainage device for draining the fluid gap, or a reservoir for storing the fluid.

7. Drive device according to claim 6, wherein the flooding device comprises a pump, a pressure chamber, an electric machine under vacuum, in particular a fluid gap under vacuum, or a pre-chamber with a capsule with a propellant.

8. Drive device according to claim 6, wherein the drainage device comprises a pump, an exhauster chamber under vacuum, a self-evacuating fluid gap, or an impeller driven by the rotor.

9. Drive device according to claim 6, wherein the reservoir comprises the transmission, the pressure chamber, or the pre-chamber.

10. Drive device according to claim 6, wherein the flooding device comprises a first pump, and the drainage device comprises a second pump, wherein the reservoir comprises the transmission.

11. Drive device according to claim 10, wherein the drainage device comprises a self-evacuating fluid gap or an impeller driven by the rotor.

12. Drive device according to claim 6, wherein the flooding device comprises a pump and a pressure chamber, wherein the drainage device comprises a pump, wherein the reservoir comprises the transmission and the pressure chamber.

13. Drive device according to claim 6, wherein the flooding device comprises an electric machine under vacuum, in particular a fluid gap under vacuum, wherein the drainage device comprises an exhauster chamber under vacuum, wherein the reservoir is formed by the transmission.

14. Drive device according to claim 6, wherein the flooding device comprises a propellant capsule, in particular a gas cartridge, which is installed in a fluid-filled pre-chamber, wherein the drainage device comprises a collection chamber arranged below the electric machine, in particular the fluid gap, in the direction of gravity, wherein the reservoir comprises the pre-chamber.

15. Drive device according to claim 5, wherein gear oil, in particular the gear oil present in the transmission, is utilized as the fluid.

16. Vehicle with a drive device according to claim 1.

17. Method for braking a drive device according to claim 1 by means of the fluid gap brake, comprising the following procedure steps:
flooding the fluid gap with fluid from a reservoir by means of the flooding device;
emptying the fluid gap of fluid into a reservoir by means of the drainage device.
